(19) United States
(12) Patent Application Publication
(10) Pub. No.: US 2024/0365382 A1
(43) Pub. Date: Oct. 31, 2024

(54) INTRA-BSS ADVERTISEMENT PROCEDURE FOR R-TWT-BASED MAP COOPRDINATION

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei City (TW)

(21) Appl. No.: 18/634,708

(22) Filed: Apr. 12, 2024

Related U.S. Application Data
(60) Provisional application No. 63/462,442, filed on Apr. 27, 2023.
(60) Provisional application No. 63/531,267, filed on Aug. 7, 2023.

(51) Int. Cl. H04W 74/0816; H04W 74/04; H04W 74/08

(52) U.S. Cl. CPC H04W 74/0816; H04W 74/04; H04W 74/0891

(57) ABSTRACT

Methods and apparatuses for facilitating multi-access point (MAP) target wake time (TWT) coordination (or TWT-based MAP coordination) operations in a wireless local area network (WLAN). A method performed by a first access point (AP) comprises determining to participate in TWT coordination with a second AP operating in a second basic service set (BSS), wherein the first AP operates in a first BSS and wherein the first AP and the second AP are members of a coordinating AP set for multi-AP (MAP) TWT coordination. The method further comprises transmitting, in the first BSS, a message indicating a first broadcast TWT (B-TWT) schedule that corresponds to a second B-TWT schedule established in the second BSS.

### CROSS-REFERENCE TO RELATED APPLICATION AND CLAIM OF PRIORITY

This application claims priority under 35 U.S.C. § 119 (e) to U.S. Provisional Patent Application No. 63/462,442 filed on Apr. 27, 2023, and U.S. Provisional Patent Application No. 63/531,267 filed on Aug. 7, 2023, which are hereby incorporated by reference in their entirety.

### TECHNICAL FIELD

This disclosure relates generally to low latency operations in wireless communications systems. Embodiments of this disclosure relate to methods and apparatuses that facilitate coordination between access points operating in different basic service sets in a wireless local area network communications system.

### BACKGROUND

Wireless local area network (WLAN) technology allows devices to access the internet in the 2.4 gigahertz (GHz), 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Next generation extremely high throughput (EHT) WI-FI systems, e.g., IEEE 802.11be, support multiple bands of operation, called links, over which an access point (AP) and a non-AP device can communicate with each other. Thus, both the AP and non-AP device may be capable of communicating on different bands/links, which is referred to as multi-link operation (MLO). The WI-FI (wireless fidelity) devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA).

Target wake time (TWT) is one of the most important features for power management in WI-FI networks, which was developed by IEEE 802.11ah and later adopted and modified into IEEE 802.11ax. TWT allows an AP to manage activity in the BSS (basic service set) to minimize contention between STAs and reduce the required amount of time that a STA utilizing a power management mode needs to be awake. This is achieved by allocating STAs to operate at nonoverlapping times and/or frequencies and concentrating the frame exchange sequences in predefined service periods. With TWT operation, it suffices for a STA to only wake up at a pre-scheduled time negotiated with another STA or AP in the network. A STA does not need to be aware of the values of TWT parameters of the TWT agreements of other STAs in the BSS of the STA or of TWT agreements of STAs in other BSSs. A STA does not need to be aware that a TWT service period (SP) is used to exchange frames with other STAs. Frames transmitted during a TWT SP are carried in any PPDU format supported by the pair of STAs that have established the TWT agreement corresponding to that TWT SP, including HE MU PPDU, HE TB PPDU, etc.

In IEEE 802.11 standards, two types of TWT operation are possible-individual TWT operation and broadcast TWT operation. Individual TWT agreements can be established between two STAs or between a STA and an AP. The negotiation that takes place for an individual TWT agreement between two STAs is on an individual basis. The AP can have TWT agreements with multiple STAs. Any changes in the TWT agreement between the AP and one STA do not affect the TWT agreement between the AP and the other STA.

IEEE 802.11ax first introduced the broadcast TWT (bTWT or B-TWT) operation. The broadcast TWT operates in a membership-based approach. With broadcast TWT operation, an AP can set up a shared TWT session for a group of STAs. The AP is typically the controller of the broadcast TWT schedule. The non-AP STAs in the BSS can request membership in the schedule, or the AP can send an unsolicited response to the STA to make the STA a member of the broadcast TWT schedule the AP maintains in the BSS. The AP can advertise/announce and maintain multiple broadcast TWT schedules in the network. When a change is made to any of the schedules in the network, it affects all the STAs that are members of that particular schedule.

TWT enhancements for multi-link devices have recently been introduced in the IEEE 802.11be specification. For individual TWT agreements between two MLDs, a STA affiliated with an MLD, which is a TWT requesting STA, may indicate the links that are requested for setting up TWT agreements in the Link ID Bitmap subfield, if present, of a TWT element in the TWT request. If only one link is indicated in the Link ID Bitmap subfield of the TWT element, then a single TWT agreement is requested for the STA affiliated with the same MLD, which is operating on the indicated link. The Target Wake Time field of the TWT element shall be in reference to the TSF time of the link indicated by the TWT element. A TWT responding STA affiliated with a peer MLD that receives a TWT request that contains a Link ID Bitmap subfield in a TWT element shall respond with a TWT response that indicates the links in the Link ID Bitmap field of a TWT element. The links, if present, in the TWT element carried in the TWT response, shall be the same as the links indicated in the TWT element of the soliciting TWT request.

Restricted TWT (rTWT or R-TWT) operation is another key feature introduced in IEEE 802.11be standards with a view to providing better support for latency-sensitive applications. Restricted TWT offers a protected service period for its member STAs by sending Quiet elements to other STAs in the BSS which are not a member of the rTWT schedule, where the Quiet interval corresponding to the Quiet element overlaps with the initial portion of the restricted TWT SP. Hence, it gives more channel access opportunities for the rTWT member scheduled STAs, which helps latency-sensitive traffic flow.

### SUMMARY

Embodiments of the present disclosure provide methods and apparatuses that facilitate multi-AP (MAP) TWT coordination (or TWT-based MAP coordination) operations in a WLAN.

In one embodiment, a method performed by a first AP comprises determining to participate in TWT coordination with a second AP operating in a second BSS, wherein the first AP operates in a first BSS and wherein the first AP and the second AP are members of a coordinating AP set for MAP TWT coordination. The method further comprises transmitting, in the first BSS, a message indicating a first B-TWT schedule that corresponds to a second B-TWT schedule established in the second BSS.

In another embodiment, a method performed by a wireless STA comprises receiving, in a first BSS from a first AP, a message indicating a first B-TWT schedule that corresponds to a second B-TWT schedule established in a second BSS, and adjusting operations of the STA based on the message to account for the first B-TWT schedule. The STA and the first AP operate in the first BSS. The first AP and a second AP operating in the second BSS are members of a coordinating AP set for multi-AP (MAP) TWT coordination, and the first AP has determined to participate in TWT coordination with the second AP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example timing diagram of individual TWT operation according to embodiments of the present disclosure;

FIG. 4 illustrates an example timing diagram of broadcast TWT operation according to embodiments of the present disclosure;

FIG. 5 illustrates an example deployment scenario for TWT-based Multi-AP coordination according to embodiments of the present disclosure;

FIG. 6 illustrates an example timing diagram of an Intra-BSS advertisement procedure for TWT-based MAP coordination according to embodiments of the present disclosure;

FIG. 7 illustrates an example flow chart of an Intra-BSS advertisement procedure for TWT-based MAP coordination according to embodiments of the present disclosure;

FIG. 8 illustrates an example timing diagram of another Intra-BSS advertisement procedure for TWT-based MAP coordination according to embodiments of the present disclosure;

FIG. 9 illustrates an example timing diagram of another Intra-BSS advertisement procedure for TWT-based MAP coordination according to embodiments of the present disclosure;

FIG. 10 illustrates an example timing diagram of another Intra-BSS advertisement procedure for TWT-based MAP coordination according to embodiments of the present disclosure;

FIG. 11 illustrates an example timing diagram of operation of a STA in a second BSS upon observing an Intra-BSS TWT advertisement of a second R-TWT schedule advertised in the second BSS with an indication that the second R-TWT schedule is not for an R-TWT scheduled STA in the second BSS or with the indication that the second R-TWT schedule is an OBSS R-TWT schedule according to embodiments of the present disclosure;

FIG. 12 is an example flow chart of a procedure for operation of a STA in a second BSS upon observing an Intra-BSS TWT advertisement of a second R-TWT schedule advertised in the second BSS with an indication that the second R-TWT schedule is not for an R-TWT scheduled STA in the second BSS or with the indication that the second R-TWT schedule is an OBSS R-TWT schedule according to embodiments of the present disclosure;

FIG. 13 illustrates another example timing diagram of operation of a STA in a second BSS upon observing an Intra-BSS TWT advertisement of a second R-TWT schedule advertised in the second BSS with an indication that the second R-TWT schedule is not for an R-TWT scheduled STA in the second BSS or with the indication that the second R-TWT schedule is an OBSS R-TWT schedule according to embodiments of the present disclosure;

FIG. 14 is an example flow chart of a procedure for operation of a STA in a second BSS upon observing an Intra-BSS TWT advertisement of a second R-TWT schedule advertised in the second BSS with an indication that the second R-TWT schedule is not for an R-TWT scheduled STA in the second BSS or with the indication that the second R-TWT schedule is an OBSS R-TWT schedule according to embodiments of the present disclosure;

FIG. 15 illustrates an example format of a Control field of a TWT element containing the indication of the OBSS TWT according to embodiments of the present disclosure;

FIG. 16 illustrates an example framework for MAP TWT coordination including the different phases according to embodiments of the present disclosure;

FIG. 17 illustrates an example timing diagram of frame exchanges for the MAP TWT Announcement and MAP TWT Negotiation phases of the MAP TWT coordination framework according to embodiments of the present disclosure;

FIG. 18 illustrates an example timing diagram of a TWT shared AP advertising and establishing a coordinated R-TWT schedule in its own BSS according to embodiments of the present disclosure; and

FIG. 19 illustrates an example process for facilitating MAP TWT coordination operations in a WLAN according to various embodiments of the present disclosure.

### DETAILED DESCRIPTION

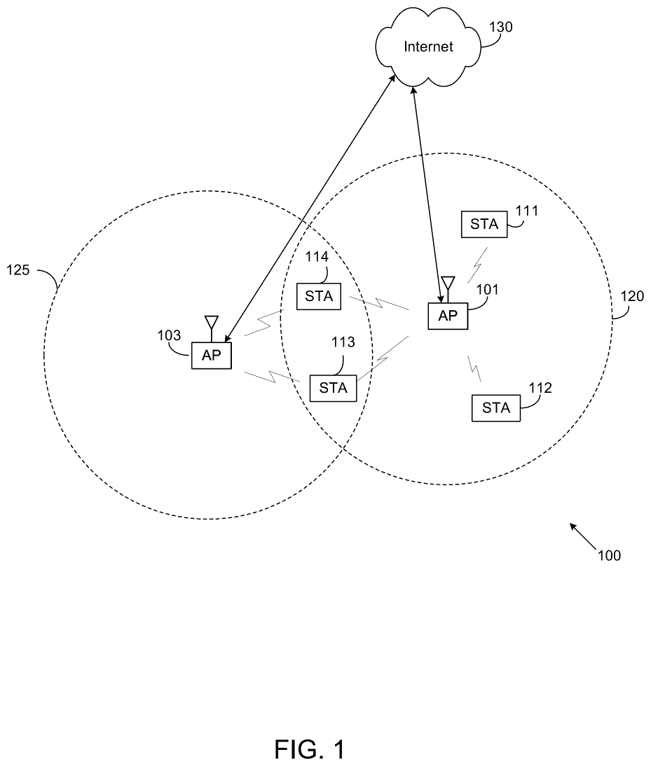

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that interference from one BSS often causes performance issues for STAs and APs in nearby BSSs. This naturally results in overall throughput degradation in the network. This Overlapping BSS (OBSS) interference can also increase the overall latency since it takes more time for accessing the channel due to the interference occupying the channel. If a STA in a BSS has latency-sensitive traffic, this delay in channel access can seriously hamper the STA's latency-sensitive applications.

Embodiments of the present disclosure further recognize that multi-AP (MAP) coordination, and in particular TWT-based MAP coordination, can address the above issue by allowing for better management of OBSS interference, however there is currently no mechanism defined for the advertisement/announcement procedure that would be needed for TWT-based MAP coordination (e.g., a procedure whereby an AP can advertise broadcast TWT or restricted TWT schedules in its BSS). Accordingly, embodiments of the present disclosure provide procedures and devices that facilitate MAP TWT coordination (or TWT-based MAP coordination) operations in a WLAN.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using WI-FI or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

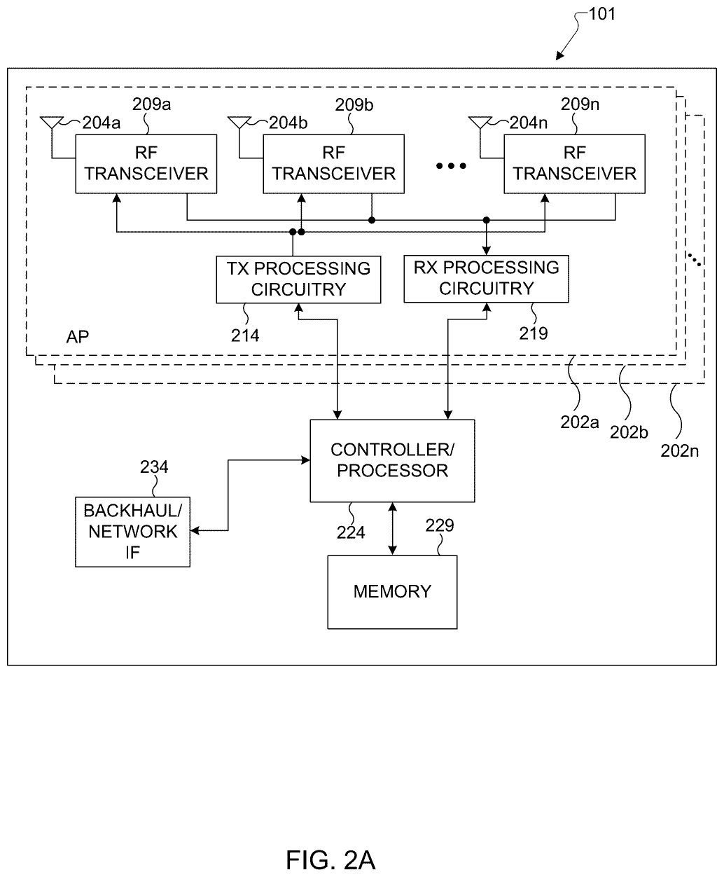

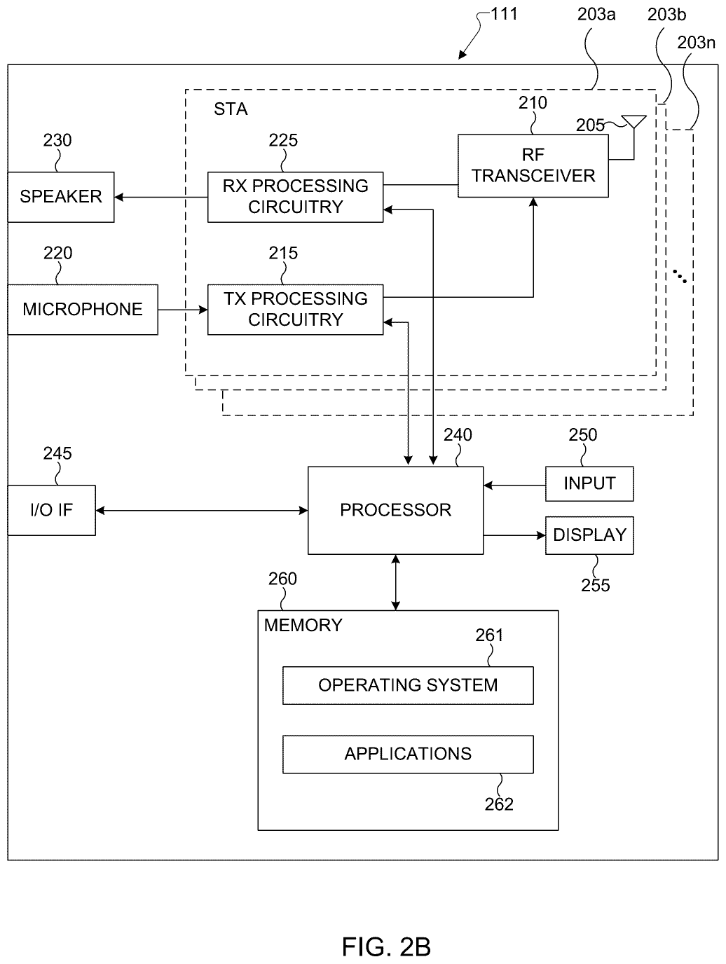

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). The controller/processor 224 could also facilitate multi-AP (MAP) TWT coordination (or TWT-based MAP coordination) operations in a WLAN. Any of a wide variety of other functions could be supported in the AP MLD 101 by the controller/processor 224. In some embodiments, the controller/processor 224 includes at least one microprocessor or microcontroller. The controller/processor 224 is also capable of executing programs and other processes resident in the memory 229, such as operations for facilitating MAP TWT coordination operations in a WLAN. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHZ, or 6 GHZ, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate MAP TWT coordination operations in a WLAN. In some embodiments, the controller/processor 240 includes at least one microprocessor or microcontroller.

The controller/processor 240 is also capable of executing other processes and programs resident in the memory 260, such as operations for facilitating MAP TWT coordination operations in a WLAN. The controller/processor 240 can move data into or out of the memory 260 as required by an executing process. In some embodiments, the controller/processor 240 is configured to execute a plurality of applications 262, such as applications for facilitating MAP TWT coordination operations in a WLAN. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

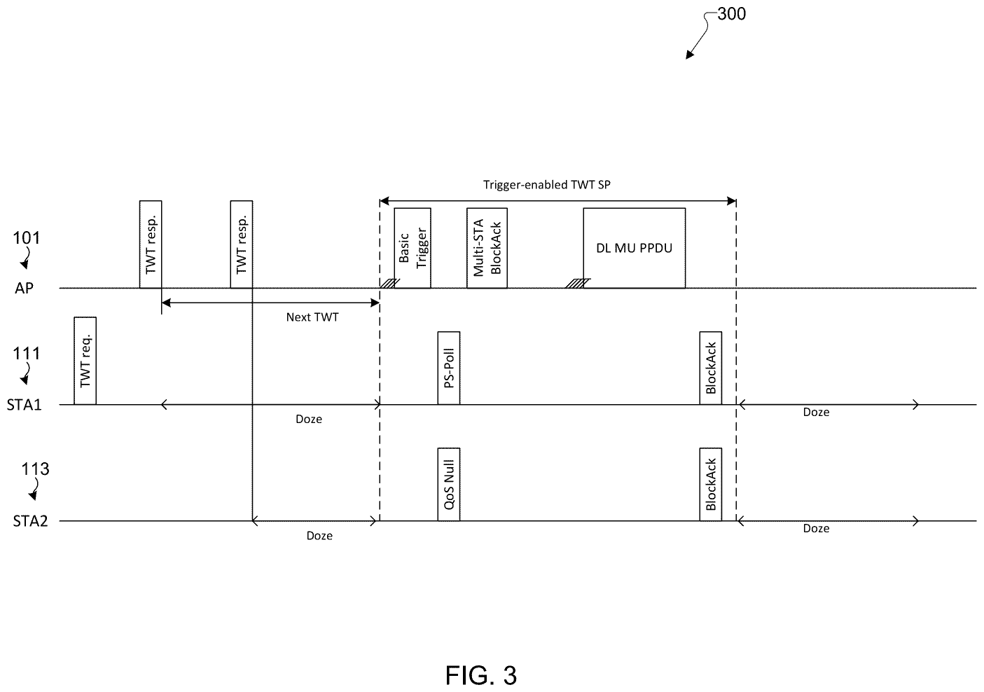

FIG. 3 illustrates an example timing diagram 300 of individual TWT operation according to embodiments of the present disclosure. In the example of FIG. 3, the AP may be one of WI-FI APs 101 and 103, and STA1 and STA2 may each be one of WI-FI STAs 111-114. For simplicity, the AP is considered to be AP 101 and STA1 and STA2 are considered to be STA 111 and STA 113, respectively. It is understood, however, that the AP may be an AP MLD or any other suitable device and the STAs may be non-AP MLDs or any other suitable device.

As illustrated in FIG. 3, STA1 sends a TWT request to the TWT responding STA to setup a trigger-enabled TWT agreement. The TWT responding STA accepts the TWT agreement with STA1 and confirms the acceptance in the TWT response sent to STA1. Subsequently, the TWT responding STA sends an unsolicited TWT response to STA2 to set up a trigger-enabled TWT agreement with STA2. Both these TWT agreements are set up as announced TWTs. During the trigger-enabled TWT SP, the TWT responding STA sends a Basic Trigger frame to which the TWT requesting STAs indicate that they are awake during the TWT SP. STA1 indicates that it is awake by sending a PS-Poll frame, and STA2 indicates that it is awake by sending a QoS Null frame in response to the Basic Trigger frame. The STA1 and STA2 subsequently go to doze state after receiving the DL BUs from the AP and sending the BlockAck frame to the AP, respectively.

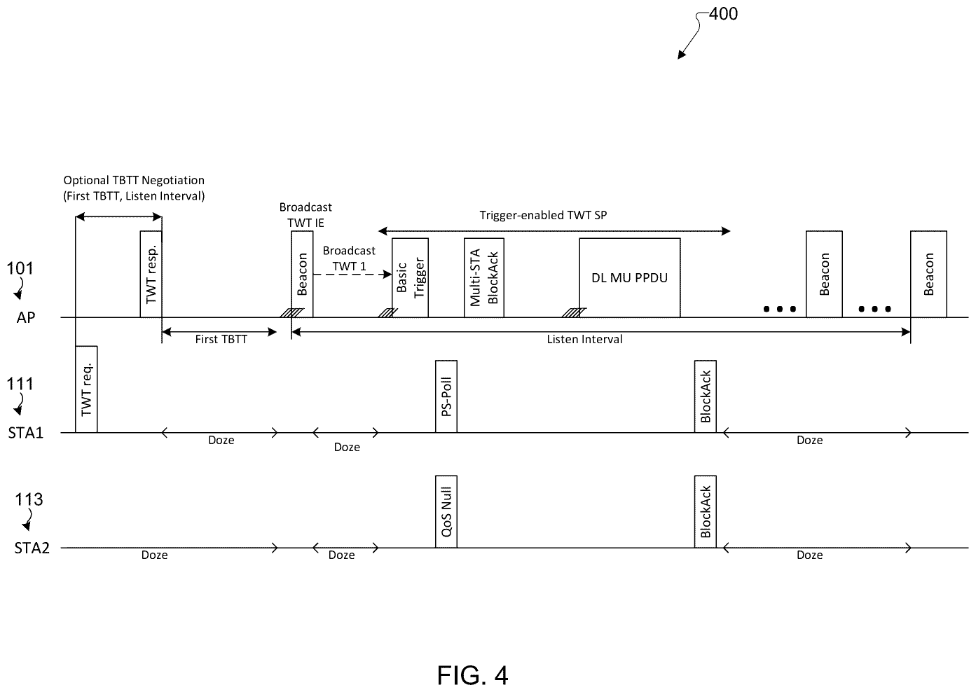

FIG. 4 illustrates an example timing diagram 400 of broadcast TWT operation according to embodiments of the present disclosure. In the example of FIG. 4, the AP may be one of WI-FI APs 101 and 103, and STA1 and STA2 may each be one of WI-FI STAs 111-114. For simplicity, as in the example of FIG. 3 the AP is considered to be AP 101 and STA1 and STA2 are considered to be STA 111 and STA 113, respectively. It is understood, however, that the AP may be an AP MLD or any other suitable device and the STAs may be non-AP MLDs or any other suitable device.

Interference from one BSS often causes performance issues for STAs and APs in nearby BSSs. This naturally results in overall throughput degradation in the network. This Overlapping BSS (OBSS) interference can also increase the overall latency since it takes more time for accessing the channel due to the interference occupying the channel. If a STA in a BSS has latency-sensitive traffic, this delay in channel access can seriously hamper the STA's latency-sensitive applications. In order to better manage the OBSS interference, Multi-AP (MAP) coordination is considered one of the key enablers for the next-generation WLAN system (e.g., WI-FI 8). In particular, TWT-based Multi-AP coordination is likely to be an important feature for the next-generation WI-FI networks (e.g., 802.11bn).

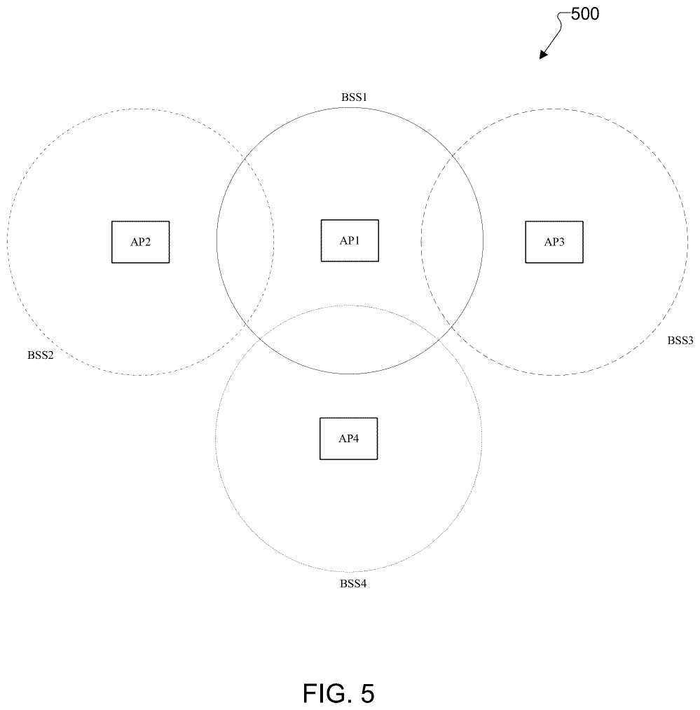

FIG. 5 illustrates an example deployment scenario 400 for TWT-based Multi-AP coordination according to embodiments of the present disclosure. An AP that has (or intends to have) a TWT schedule/agreement in its BSS and initiates a TWT coordination procedure with OBSS APs for better protection (e.g., to increase channel access opportunity or reduce OBSS interference) of the TWT SPs is referred to as a “TWT sharing AP”. An AP that is the recipient of the TWT coordination request from the TWT sharing AP is referred to as a “TWT shared AP”.

For broadcast TWT or restricted TWT, the intra-BSS TWT announcement procedure, through which the TWT shared AP advertises the corresponding broadcast TWT or restricted TWT schedules in its BSS, is a critical step. Accordingly, the present disclosure provides mechanisms and procedures for this advertisement/announcement procedure that would be needed for TWT-based Multi-AP coordination.

According to one embodiment, in some modes of R-TWT-based multi-AP coordination, when a first AP that is an R-TWT sharing AP operating in a first BSS has a first R-TWT schedule established in the first BSS and the first AP is also a member of an R-TWT coordinating AP set, if a second AP operating in a second BSS is also a member of the R-TWT coordinating AP set and agrees to participate in the R-TWT coordination with the first AP, then the second AP advertises the same R-TWT schedule in the second BSS as the first R-TWT schedule advertised by the first AP in the first BSS. When the second AP advertises the R-TWT schedule in the second BSS, the second AP can ensure that the target wake time value, which may be indicated in the Target Wake Time subfield in the Broadcast TWT Parameter Set field corresponding to the R-TWT schedule, in the TWT element is in reference to the TSF timer value of the second AP in the second BSS such that the target wake time value corresponding to the R-TWT schedule advertised in the first BSS and the target wake time value corresponding to the R-TWT schedule advertised in the second BSS are aligned with each other.

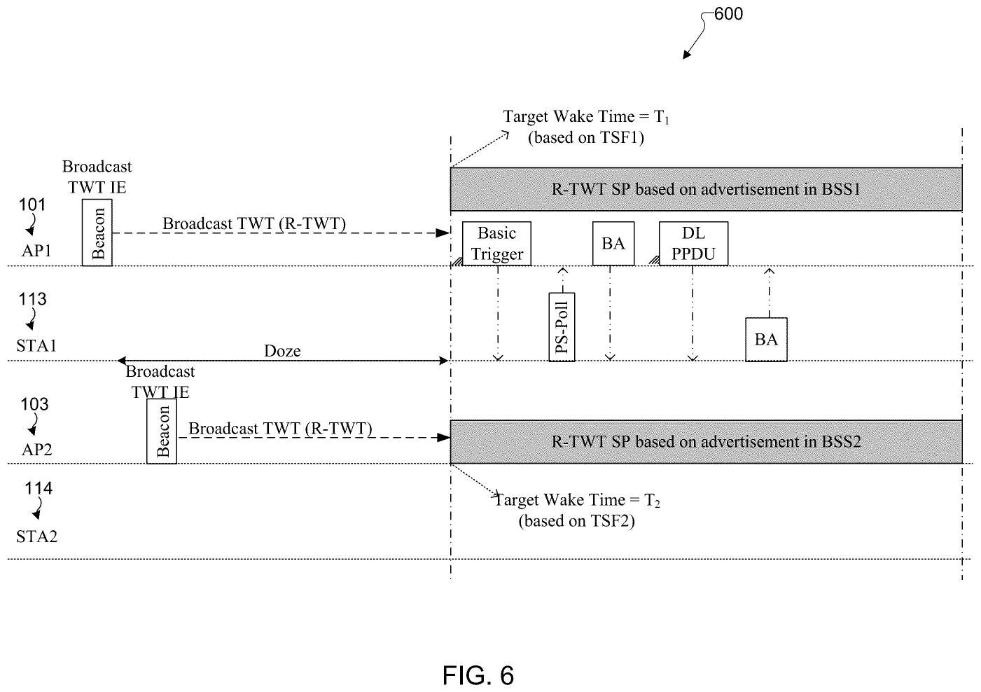

FIG. 6 illustrates an example timing diagram 600 of an Intra-BSS advertisement procedure for TWT-based MAP coordination according to embodiments of the present disclosure. The Intra-BSS advertisement procedure for TWT-based MAP coordination is a broadcast TWT or restricted TWT schedule advertisement procedure in one BSS for a schedule originally established for another BSS, wherein both APs participate in a coordinated TWT mechanism and the same TWT SPs are advertised in both BSSs.

In the example of FIG. 6, AP1 and AP2 may each be one of WI-FI APs 101 and 103, and STA1 and STA2 may each be one of WI-FI STAs 111-114. For ease of discussion, references to AP1 and AP2 in this and further embodiments of the present disclosure are considered to refer to AP 101 and AP 103, respectively, and references to STA1 and STA2 are considered to refer to STA 113 and STA 114, respectively. It is understood, however, that the AP may be an AP MLD or any other suitable device and the STAs may be non-AP MLDs or any other suitable device. Additionally, for ease of discussion the example of FIG. 6 discusses R-TWT, but it is understood that B-TWT operations may also be used in place of R-TWT operations in this and other embodiments of the present disclosure.

In the example of FIG. 6, AP1 forms a first BSS, BSS1. AP2 forms a second BSS, BSS2. AP1 maintains a first timing synchronization function (TSF) TSF1 in BSS1. AP2 maintains a second TSF, TSF2, in BSS2. STA1 operates in BSS1 and is an R-TWT scheduled STA, while AP1 is an R-TWT scheduling AP. STA2 operates in BSS2. STA1's R-TWT schedule starts at the time T₁, which corresponds to the target wake time value of the R-TWT schedule and is based on TSF1. AP1 and AP2 form a TWT-based coordinating AP set for TWT-based multi-AP coordination. Therefore, AP2 also advertises an R-TWT schedule in BSS2 that corresponds to the R-TWT schedule in BSS1 (which is advertised by AP1).

When AP2 advertises the R-TWT schedule in BSS2, the target wake time value (as indicated in the Target Wake Time subfield in the Broadcast TWT Parameter Set field corresponding to the R-TWT schedule in the TWT element) is set to T₂, based on TSF2. As illustrated in FIG. 6, although the numeric values of T₁ and T₂ may be different (since TSF1 and TSF2 may be different), the target wake time values (T₁ and T₂) are configured to be aligned in time. The TWT parameters (except for the Target Wake Time) corresponding to the R-TWT schedule advertised in BSS2 are otherwise the same as the TWT parameters corresponding to the R-TWT schedule in BSS1.

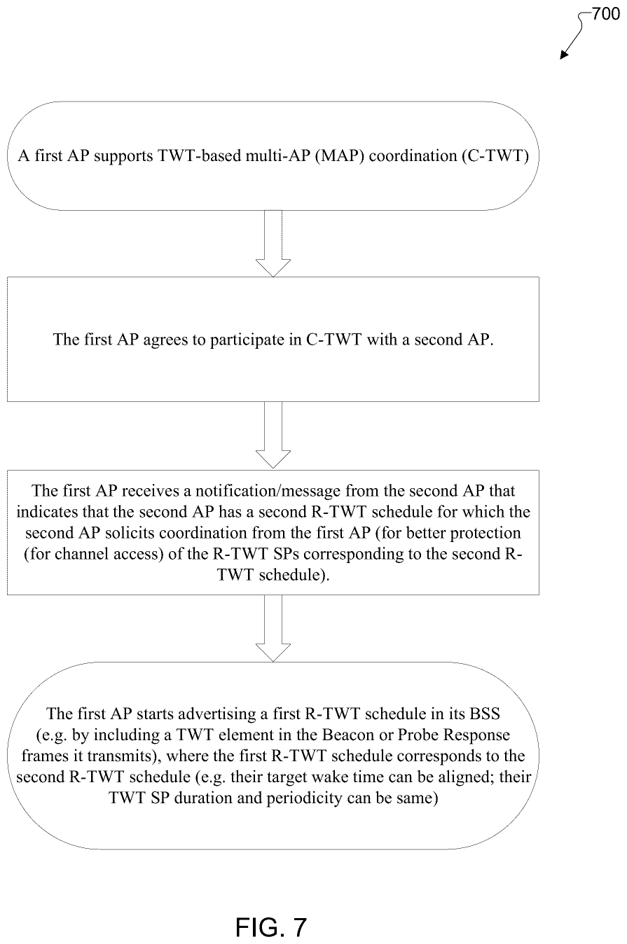

FIG. 7 illustrates an example flow chart 700 of an Intra-BSS advertisement procedure for TWT-based MAP coordination according to embodiments of the present disclosure.

According to one embodiment, in some modes of R-TWT-based multi-AP coordination, when a first AP that is an R-TWT sharing AP operating in a first BSS has a first R-TWT schedule established in the first BSS and the first AP is also a member of an R-TWT coordinating AP set, if a second AP operating in a second BSS is also a member of the R-TWT coordinating AP set and agrees to participate in the R-TWT coordination with the first AP, then in order to provide protection for the first R-TWT schedule in the first BSS, the second AP may advertise an R-TWT schedule in the second BSS that is not exactly the same as the first R-TWT schedule in the first BSS. That is, the TWT parameters corresponding to the second R-TWT schedule in the second BSS can be different from the TWT parameters corresponding to the first R-TWT schedule in the first BSS. For example, while the target wake time value corresponding to the second R-TWT schedule in the second BSS can be aligned in time with the target wake time value corresponding to the first R-TWT schedule in the first BSS, the periodicity of the TWT SPs (or other TWT parameters) of the second R-TWT schedule in the second BSS can be different from the periodicity of the TWT SPs of the first R-TWT schedule in the first BSS.

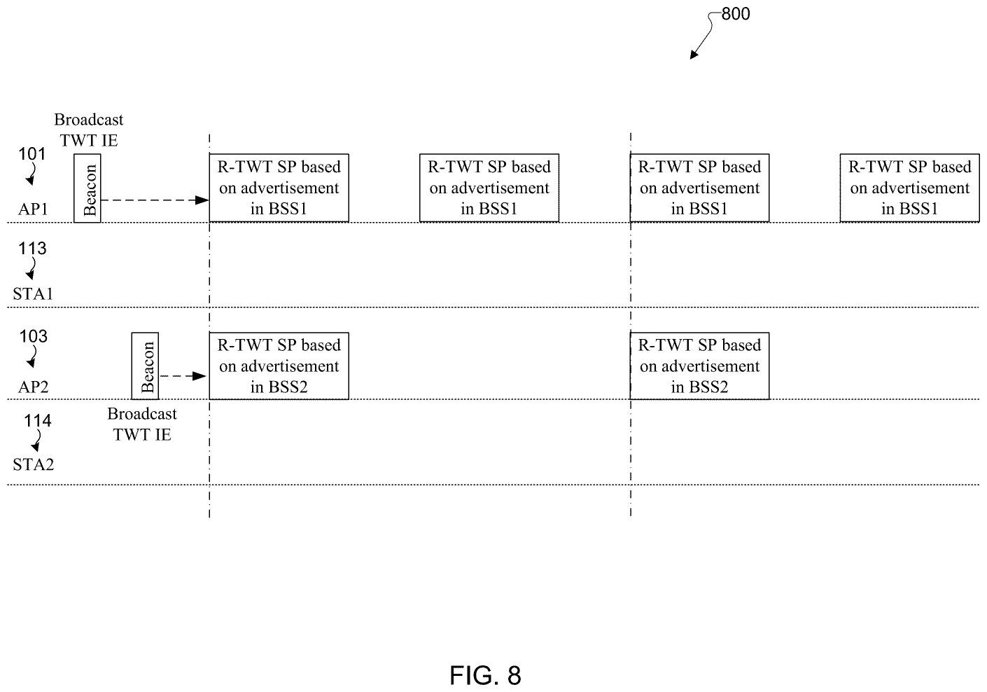

FIG. 8 illustrates an example timing diagram 800 of another Intra-BSS advertisement procedure for TWT-based MAP coordination according to embodiments of the present disclosure. In the example of FIG. 8, the periodicity of the TWT SPs advertised in BSS2 is different from the periodicity of the TWT SPs advertised in BSS1.

The example of FIG. 8 has the same network setup as the example of FIG. 6. In this example, although the target wake time value and the SP duration corresponding to the R-TWT schedule advertised in BSS2 are aligned with the target wake time value and the SP duration corresponding to the R-TWT schedule advertised in BSS1, the periodicity of the R-TWT schedule advertised in BSS2 is different from the periodicity of the schedule advertised in BSS1. Otherwise, all TWT parameters corresponding to the R-TWT schedule advertised in BSS2 are the same as those corresponding to the R-TWT schedule advertised in BSS1.

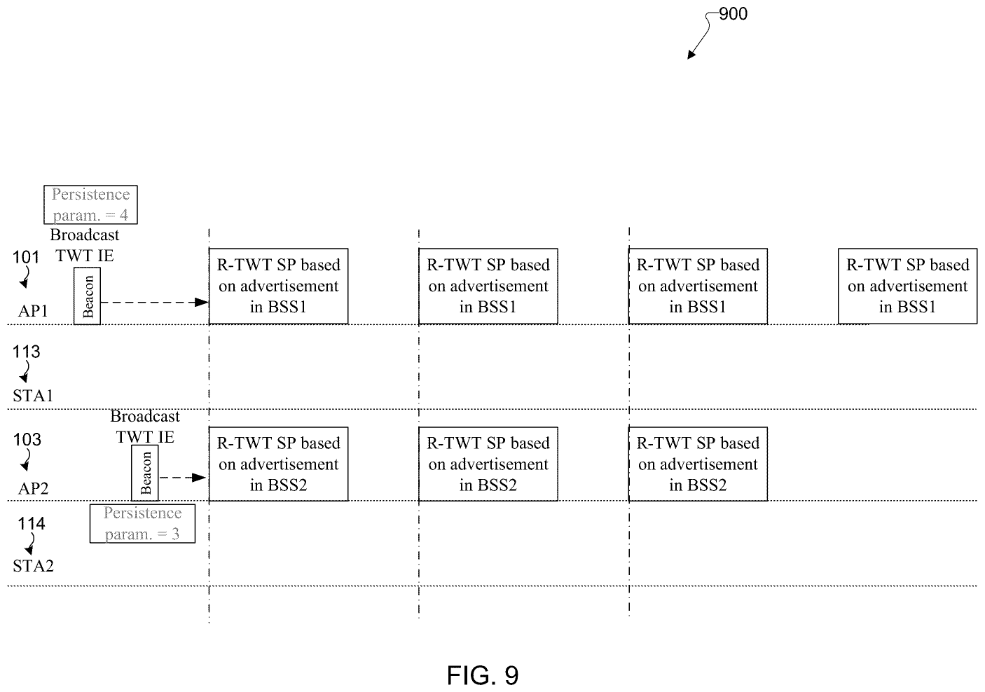

FIG. 9 illustrates an example timing diagram 900 of another Intra-BSS advertisement procedure for TWT-based MAP coordination according to embodiments of the present disclosure. FIG. 9 illustrates another example in which one TWT parameter of the two R-TWT schedules advertised in the two BSSs is different, with all other TWT parameters being the same. In particular, FIG. 9 illustrates an example in which the persistence parameters of the two schedules advertised in the two BSSs are different.

The example of FIG. 9 is similar to the example of FIG. 8, except that the periodicity of the R-TWT schedule advertised in BSS2 is the same as the periodicity of the R-TWT schedule advertised in BSS1. However, the persistence parameter corresponding to the R-TWT schedule advertised in BSS1 is set to 4 while the persistence parameter corresponding to the R-TWT schedule advertised in BSS2 is set to 3. All other TWT parameters of the two schedules are the same.

According to one embodiment, in some modes of R-TWT-based multi-AP coordination, when a first AP that is an R-TWT sharing AP operating in a first BSS has a first R-TWT schedule established in the first BSS such that the first schedule is valid for N1 TWT SPs in the first BSS and the first AP is also a member of an R-TWT coordinating AP set, if a second AP operating in a second BSS is also a member of the R-TWT coordinating AP set and agrees to participate in the R-TWT coordination with the first AP, then in order to provide protection for the first R-TWT schedule in the first BSS, the second AP may advertise a second R-TWT schedule in the second BSS such that the second R-TWT schedule is aligned with the first R-TWT schedule in the first BSS, but the second R-TWT schedule remains valid for N2 SPs. According to one embodiment, N1<N2. According to another embodiment, N1=N2. According to yet another embodiment, N1>N2.

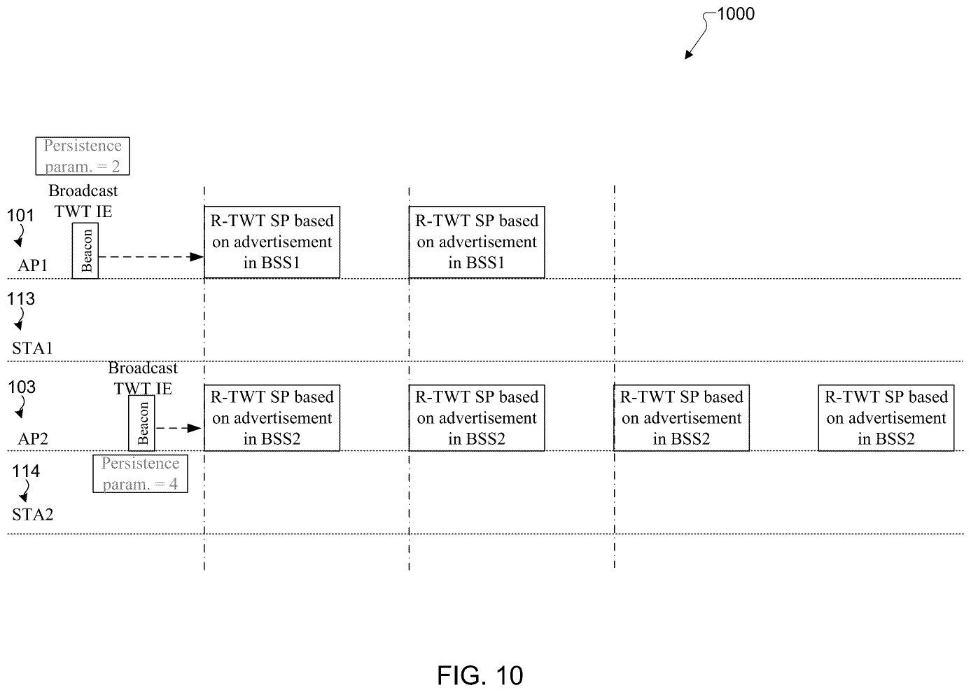

FIG. 10 illustrates an example timing diagram 1000 of another Intra-BSS advertisement procedure for TWT-based MAP coordination according to embodiments of the present disclosure. FIG. 10 illustrates an example of the embodiment for the case where N1<N2. That is, the R-TWT schedule corresponding to the TWT sharing AP's BSS (BSS1) remains valid for more SPs in the TWT shared AP's BSS (BSS2) than it remains valid in the sharing AP's BSS.

The example of FIG. 10 has the same network setup as the example of FIG. 6. That is, AP1 forms a BSS, BSS1, AP2 forms a BSS, BSS2, STA1 operating in BSS1 is an R-TWT scheduled STA, and AP1 is an R-TWT scheduling AP. STA1 is a member of the first R-TWT schedule in BSS1. AP1 and AP2 form a TWT-based coordinating AP set, and therefore AP2 advertises a second R-TWT schedule in BSS2 that corresponds to the first R-TWT schedule in BSS1 that is advertised by AP1 such that the target wake time of the first and second R-TWT schedules in the BSS1 and BSS2, respectively, are aligned. In the example of FIG. 10, based on the advertisement made by AP1 in BSS1, the first R-TWT schedule remains valid for two SPs (persistence parameter=2) in BSS1, but based on the advertisement made by AP2 in BSS2, the second R-TWT schedule in BSS2 remains valid for four SPs (persistence parameter=4).

According to one embodiment, in some modes of R-TWT-based multi-AP coordination, when a first AP that is an R-TWT sharing AP operating in a first BSS has a first R-TWT schedule established in the first BSS such that the first schedule is valid for N1 SPs in the first BSS and the first AP is also a member of an R-TWT coordinating AP set, if a second AP operating in a second BSS is also a member of the R-TWT coordinating AP set and agrees to participate in the R-TWT coordination with the first AP, then in order to provide protection for the first R-TWT schedule in the first BSS, if the second AP advertises a second R-TWT schedule in the second BSS that corresponds to the first R-TWT schedule in the first BSS, then the second AP, while advertising the second R-TWT schedule in the second BSS, can indicate that the second R-TWT schedule in the second BSS is not for any R-TWT scheduled STA in the second BSS (i.e., no STA in the second BSS is a member of this advertised R-TWT schedule in the second BSS). Moreover, the second AP can indicate that the second R-TWT schedule advertised in the second BSS is for an R-TWT scheduled STA in the first BSS (i.e., the second R-TWT schedule advertised in the second BSS is an OBSS R-TWT schedule).

If a STA operating in the second BSS and associated with the second AP observes the second R-TWT schedule advertised in the second BSS with the indication that the second R-TWT schedule is not for an R-TWT scheduled STA in the second BSS or with the indication that the second R-TWT schedule is an OBSS R-TWT schedule, then the STA can abide by the following rules:

The STA can end its transmission opportunity (TXOP), if the STA is the TXOP owner, before an R-TWT SP corresponding to the second R-TWT schedule advertised in the second BSS if the second R-TWT schedule advertised in the second BSS is an active R-TWT schedule (i.e., there is at least one STA in the first BSS that is a member of the first R-TWT schedule in the first BSS) as indicated in the Broadcast TWT Parameter Set field corresponding to the R-TWT schedule in the TWT element (e.g., such indication can be made by setting the Restricted TWT Schedule Info subfield in the corresponding Broadcast TWT Parameter Set field to either 1 or 2 or 3).

The STA may not end its TXOP (if the STA is the TXOP owner) before an R-TWT SP corresponding to the second R-TWT schedule advertised in the second BSS if the second R-TWT schedule advertised in the second BSS is an idle or inactive R-TWT schedule (i.e., there is no member of the first R-TWT schedule in the first BSS) as indicated in the Broadcast TWT Parameter Set field corresponding to the R-TWT schedule in the TWT element (e.g., such indication can be made by setting the Restricted TWT Schedule Info subfield in the corresponding Broadcast TWT Parameter Set field to 0).

The STA may not send a request to the second AP to become a member of the second R-TWT schedule advertised by the second AP.

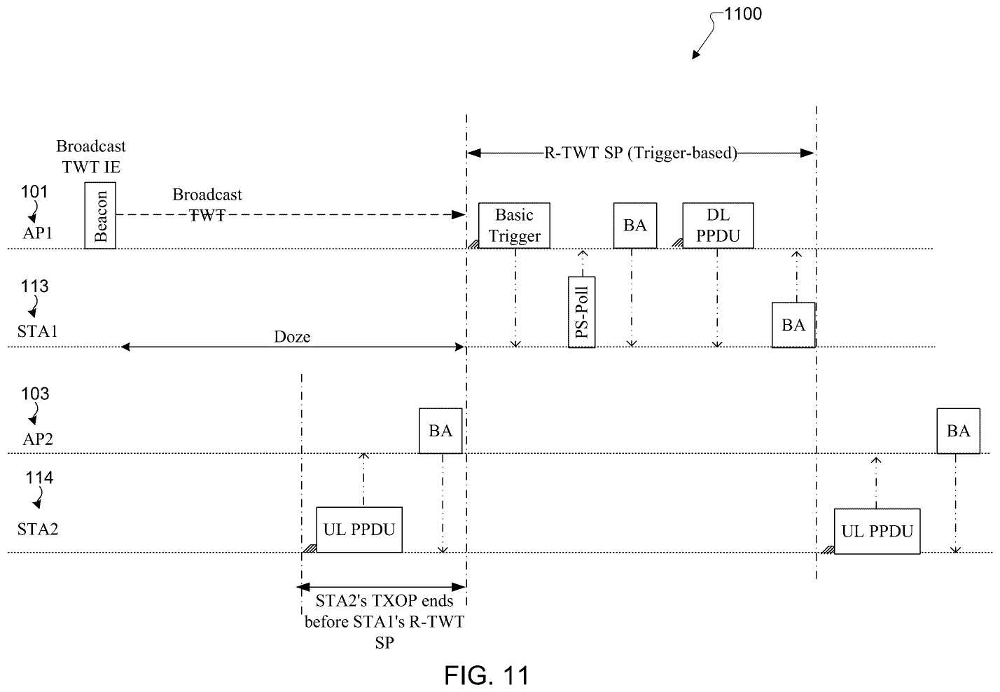

FIG. 11 illustrates an example timing diagram 1100 of operation of a STA in a second BSS upon observing an Intra-BSS TWT advertisement of a second R-TWT schedule advertised in the second BSS with an indication that the second R-TWT schedule is not for an R-TWT scheduled STA in the second BSS or with the indication that the second R-TWT schedule is an OBSS R-TWT schedule according to embodiments of the present disclosure. The example of FIG. 11 corresponds to the embodiment in which the STA in the shared AP's BSS ends its TXOP before an R-TWT SP starts in the sharing AP's BSS.

In the example of FIG. 11, AP1 forms a BSS, BSS1. AP2 forms a BSS, BSS2. STA1 in BSS1 is an R-TWT scheduled STA and AP1 is an R-TWT scheduling AP. STA1 is a member of the first R-TWT schedule in BSS1. AP1 and AP2 form a TWT-based coordinating AP set. Therefore, AP2 also advertises a second R-TWT schedule in BSS2 that corresponds to the R-TWT schedule in BSS1 that is advertised by AP1. The two R-TWT schedules advertised in the two BSSs are aligned (e.g., aligned in target wake time, periodicity, and SP duration).

Since STA1 is a member of the first R-TWT schedule in BSS1, the second R-TWT schedule in BSS2 is an active R-TWT schedule. If AP1 advertises the first R-TWT schedule in BSS1 with an indication that it is an active R-TWT schedule (such indication can be made by setting the Restricted TWT Schedule Info subfield in the corresponding Broadcast TWT Parameter Set field to either 1 or 2 or 3), then according to some embodiments AP2 can advertise the second R-TWT schedule in BSS2 with an indication that it is an active R-TWT schedule.

Upon observing the second R-TWT schedule advertised by the second AP in the second BSS, STA2, if it has been the TXOP holder, ends its TXOP before an R-TWT SP corresponding to the second R-TWT schedule advertised in the second BSS begins (i.e., before the target wake time of the R-TWT SP). After ending the TXOP before the target wake time corresponding to the R-TWT SP, STA2 associated with AP2 can start contending for the channel and can start transmission upon winning the contention.

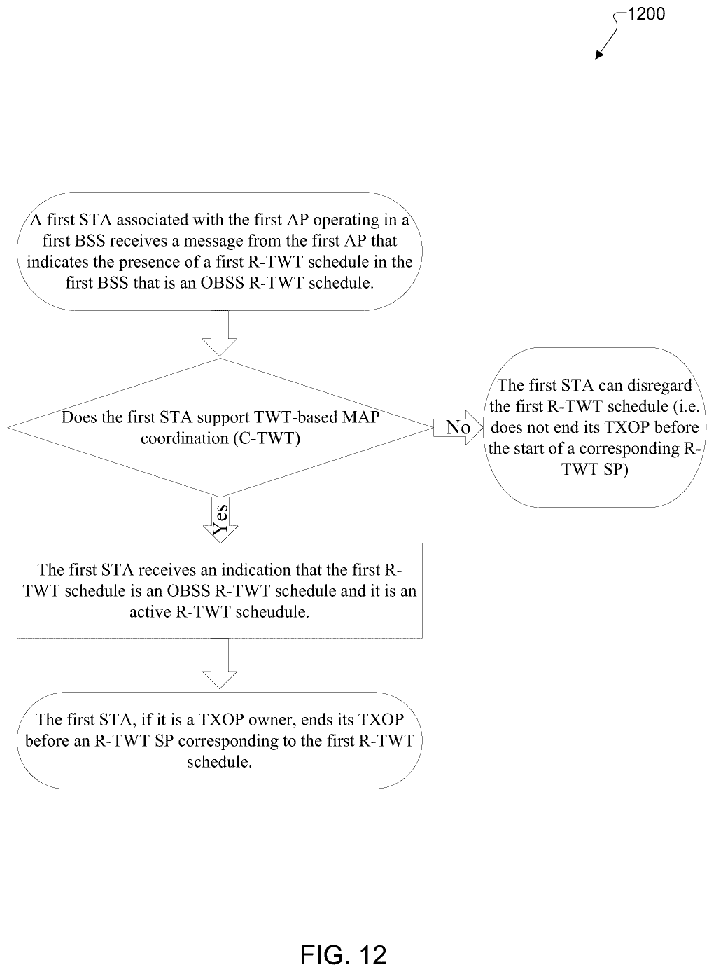

FIG. 12 is an example flow chart 1200 of a procedure for operation of a STA in a second BSS upon observing an Intra-BSS TWT advertisement of a second R-TWT schedule advertised in the second BSS with an indication that the second R-TWT schedule is not for an R-TWT scheduled STA in the second BSS or with the indication that the second R-TWT schedule is an OBSS R-TWT schedule according to embodiments of the present disclosure. The example procedure of FIG. 12 corresponds to the embodiment of FIG. 11.

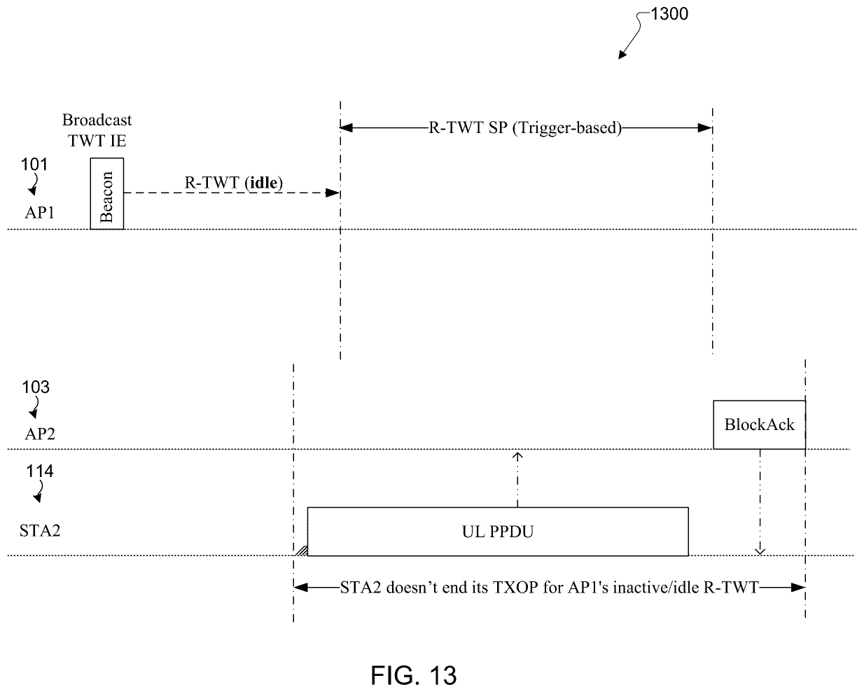

FIG. 13 illustrates another example timing diagram 1300 of operation of a STA in a second BSS upon observing an Intra-BSS TWT advertisement of a second R-TWT schedule advertised in the second BSS with an indication that the second R-TWT schedule is not for an R-TWT scheduled STA in the second BSS or with the indication that the second R-TWT schedule is an OBSS R-TWT schedule according to embodiments of the present disclosure. The example of FIG. 12 corresponds to the embodiment in which the STA in the shared AP's BSS continues its TXOP during an R-TWT SP in the sharing AP's BSS.

In the example of FIG. 13, AP1 forms a BSS, BSS1. AP2 forms a BSS, BSS2. STA1 in BSS1 is an R-TWT scheduled STA and AP1 is an R-TWT scheduling AP. STA1 is a member of the first R-TWT schedule in BSS1. AP1 and AP2 form a TWT-based coordinating AP set. Therefore, AP2 also advertises a second R-TWT schedule in BSS2 that corresponds to the R-TWT schedule in BSS1 that is advertised by AP1 (i.e., the two R-TWT schedules advertised in the two BSSs are aligned in target wake time, SP duration, and periodicity).

AP1, during the advertisement, indicates that the first R-TWT schedule in BSS1 is an idle schedule (such indication can be made by setting the Restricted TWT Schedule Info subfield in the corresponding Broadcast TWT Parameter Set field to 0). AP2, during its advertisement in BSS2, also indicates that the second R-TWT schedule is an idle/inactive schedule.

Upon observing the second R-TWT schedule advertised by the second AP (and hence the indication that the second R-TWT schedule is an idle schedule) in the second BSS, STA2, if it has been the TXOP holder, does not end its TXOP before an R-TWT SP corresponding to the second R-TWT schedule advertised in the second BSS begins (i.e., before the target wake time of the R-TWT SP).

According to some embodiments of FIG. 13, if the first AP, while advertising the first R-TWT schedule, indicates that the first R-TWT schedule is an idle/inactive schedule, then the first AP does not solicit for R-TWT-based coordination with a second AP.

According to some embodiments of FIG. 13, if the first AP, while advertising the first R-TWT schedule, indicates that the first R-TWT schedule is an idle/inactive schedule, then the second AP does not participate in R-TWT-based coordination with the first AP for protecting the first R-TWT schedule—that is, the second AP may not advertise a second R-TWT schedule in the second BSS that would correspond to the first R-TWT schedule in the first BSS (as a way to perform TWT-based coordination for the first R-TWT schedule in the first BSS).

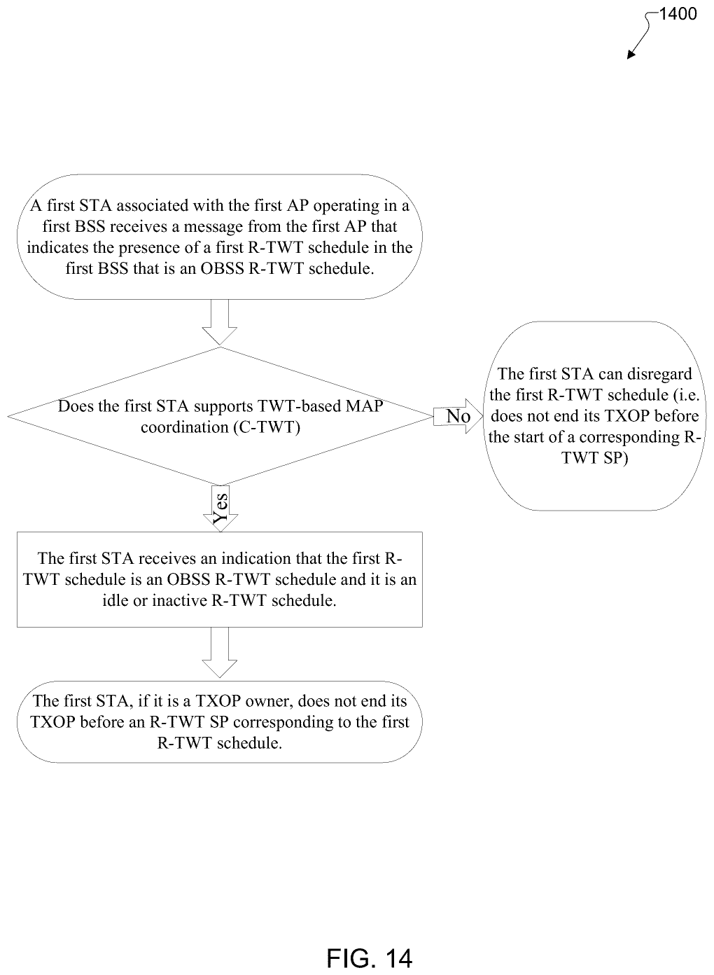

FIG. 14 is an example flow chart 1400 of a procedure for operation of a STA in a second BSS upon observing an Intra-BSS TWT advertisement of a second R-TWT schedule advertised in the second BSS with an indication that the second R-TWT schedule is not for an R-TWT scheduled STA in the second BSS or with the indication that the second R-TWT schedule is an OBSS R-TWT schedule according to embodiments of the present disclosure. The example procedure of FIG. 14 corresponds to the embodiment of FIG. 13.

In some modes of R-TWT-based multi-AP coordination, when a first AP that is an R-TWT sharing AP operating in a first BSS has a first R-TWT schedule established in the first BSS such that the first schedule is valid for N1 SPs in the first BSS and the first AP is also a member of an R-TWT coordinating AP set, if a second AP operating in a second BSS is also a member of the R-TWT coordinating AP set and agrees to participate in the R-TWT coordination with the first AP, then in order to provide protection for the first R-TWT schedule in the first BSS, if the second AP advertises a second R-TWT schedule in the second BSS that corresponds to the first R-TWT schedule in the first BSS, then the second AP, while advertising the second R-TWT schedule in the second BSS, can indicate that the second R-TWT schedule is an OBSS R-TWT schedule (e.g., corresponding to a neighboring BSS).

According to some embodiments, such an indication can be included in the Broadcast TWT Recommendation field in the Broadcast TWT Parameter Set field in the TWT element as shown in Table 1. In Table 1, a TWT schedule can be indicated to be an OBSS TWT schedule (i.e., the TWT schedule corresponds to a schedule in the neighboring BSS) by setting the Broadcast TWT Recommendation field value to 5.

TABLE 1

| Broadcast TWT | |
|---|---|
| Recommendation | Description when transmitted in a broadcast |
| field value | TWT element |
| . . . | .. . |
| 4 | The corresponding broadcast TWT SP is referred to as an R- |
| | TWT SP. |
| | During an R-TWT SP, the AP and member R-TWT scheduled |
| | STAs prioritize their transmission of QoS Data frames that are |
| | latency sensitive traffic (see 35.8 (Restricted TWT (R- TWT))). |
| 5 | The corresponding broadcast TWT SP or R-TWT SP is referred |
| | to as an OBSS TWT SP. |
| 6-7 | Reserved |

According to other embodiments, such an indication can be made in the Broadcast TWT Recommendation field in the Broadcast TWT Parameter Set field in the TWT element as shown in Table 2. In Table 2, setting the Broadcast TWT Recommendation field value to 6 indicates that the corresponding broadcast TWT schedule is an R-TWT schedule and this R-TWT schedule is an OBSS R-TWT schedule.

TABLE 2

| Broadcast TWT | |
|---|---|
| Recommendation | Description when transmitted in a broadcast |
| field value | TWT element |
| . . . | . . . |
| 4 | The corresponding broadcast TWT SP is referred to as an R- |
| | TWT SP. |
| | During an R-TWT SP, the AP and member R-TWT scheduled |
| | STAs prioritize their transmission of QoS Data frames that are |
| | latency sensitive traffic (see 35.8 (Restricted TWT (R- TWT))). |
| 5 | The corresponding broadcast TWT SP is referred to as an OBSS |
| | TWT SP. |
| 6 | The corresponding broadcast TWT SP is an R-TWT SP. The |
| | corresponding broadcast TWT SP is also an OBSS R-TWT SP. |
| 7 | Reserved |

According to some other embodiments, such an indication can be made in the Control field of the TWT element containing the Broadcast TWT Parameter Set field corresponding to the R-TWT schedule.

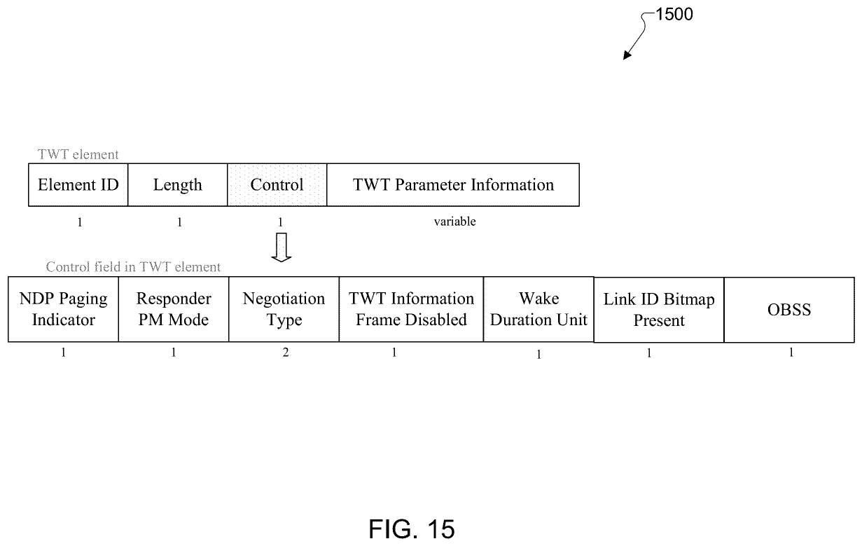

FIG. 15 illustrates an example format 1500 of a Control field of a TWT element containing the indication of the OBSS TWT according to embodiments of the present disclosure. If the OBSS subfield is set to 1, then, according to one embodiment, all the TWT schedules corresponding to the Broadcast TWT Parameter Set field contained in the TWT element are OBSS TWT schedules. According to another embodiment, it indicates that there is at least one TWT schedule corresponding to a Broadcast TWT Parameter Set field contained in the TWT element that is an OBSS TWT schedule. If the OBSS subfield is set to 0, it indicates that there no Broadcast TWT Parameter Set field contained in the TWT element that corresponds to an OBSS TWT schedule.

According to one embodiment, a first AP can advertise in its BSS about an OBSS R-TWT schedule by broadcast or individually addressed frames. A format of such a frame is shown in Table 3.

TABLE 3

| Order | Information |
|---|---|
| 1 | Category |
| 2 | Unprotected S1G Action |
| 3 | One or more TWT |

The baseline individual TWT agreement is established using a negotiation between the two STAs and the baseline broadcast/restricted TWT schedule is established through an advertisement by the AP followed by a negotiation between the AP and the STA. However, Multi-AP TWT coordination calls for additional steps.

According to one embodiment, the overall phases for TWT coordination can be listed as:
MAP TWT Announcement
MAP TWT Negotiation
Intra-BSS TWT Announcement
Intra-BSS TWT Negotiation
Maintenance of a TWT schedule/agreement
Termination of TWT coordination

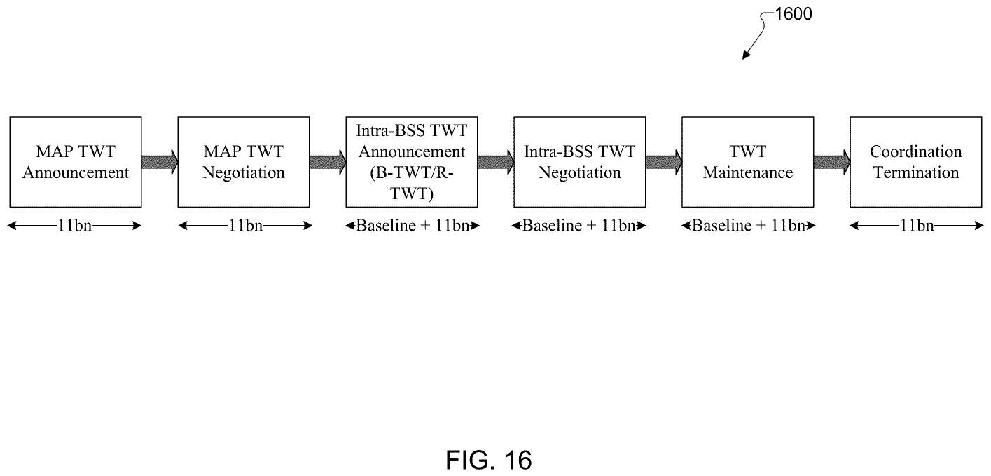

FIG. 16 illustrates an example framework 1600 for MAP TWT coordination including the different phases according to embodiments of the present disclosure.

According to one embodiment, during the MAP TWT announcement phase, the TWT sharing AP can identify the other APs that are willing to participate in TWT coordination. Basic capability and coordination information (e.g., modes of TWT coordination (iTWT/bTWT/rTWT)) can be announced during this phase. If a neighboring AP is willing and prepared to participate in the TWT coordination, it can inform the TWT sharing AP by responding to the announcement received from the TWT sharing AP. This phase essentially forms a TWT coordination group.

According to one embodiment, during the MAP TWT Negotiation phase, the TWT parameters for MAP coordination (C-TWT parameters) are decided among the participating APs. The sharing AP can send a TWT coordination request to the other APs in the TWT coordination group. Along with the C-TWT parameters, the request can also contain types of coordination. For example, if the negotiation is for an R-TWT, then the sharing AP can include the level of protection it requests from the shared APs. Upon receiving the request, the shared AP can either accept/reject the request or suggest an alternative set of C-TWT parameters.

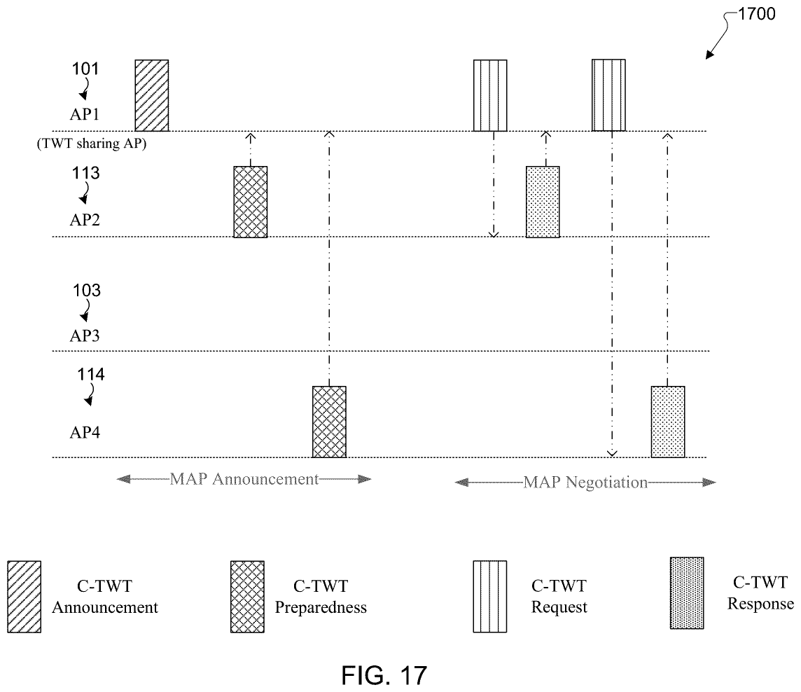

FIG. 17 illustrates an example timing diagram 1700 of frame exchanges for the MAP TWT Announcement and MAP TWT Negotiation phases of the MAP TWT coordination framework according to embodiments of the present disclosure. The example of FIG. 17 assumes wireless MAP coordination. For managed networks, frame exchanges can happen through the central controller.

According to one embodiment, when a TWT shared AP agrees to coordinate with the TWT sharing AP, based on the nature of the TWT agreement (or schedule), the shared AP can take different approaches for notifying or (announcing for) the STAs in its BSS (e.g., in the Intra-BSS TWT Announcement phase of the MAP TWT coordination framework). The TWT sharing AP's intra-BSS TWT announcement operation may follow baseline procedures.

According to a first approach, the TWT shared AP, in notifying the members of its own BSS about TWT agreements, can make a distinction between its own TWT agreements (i.e., the TWT agreements generated and maintained by the shared AP for its BSS) and the coordinated TWT agreements that the shared AP is participating in. In doing so, the shared AP can dictate the behavior expected from its associated STAs during the SPs of the coordinated TWT schedule or agreement. For example, if the MAP coordination is for an individual TWT agreement and the sharing AP requests to minimize the interference towards a victim STA in the sharing AP's BSS during the C-TWT SP, then the shared AP can indicate to interfering STAs associated with the shared AP to avoid transmission during the C-TWT SPs (and if the shared AP itself is the interfering STA, it can create a null towards the victim STA during the C-TWT SP). In another example, if the MAP coordination is for an R-TWT schedule, the shared AP can announce the corresponding C-TWT schedule in its BSS, but add a marker in the schedule to distinguish it from its own R-TWT schedule. The shared AP can establish different rules for associated STAs in regard to this C-TWT such as membership management, and differentiated TXOP ending rules.

According to a second approach, the shared AP Makes no distinction between its own TWT agreements and the coordinated TWT agreements it is participating in. This approach may be more applicable to B-TWT-based or R-TWT-based coordination than to individual TWT-based coordination. The shared AP advertises the C-TWT schedule in its BSS as if the schedule is its own TWT schedule (and the TWT timing parameter would be adapted based on the shared AP's TSF). The STAs in the shared AP's BSS are agnostic to whether the advertised schedule is a C-TWT schedule or not, and can seek membership in the coordinated schedule.

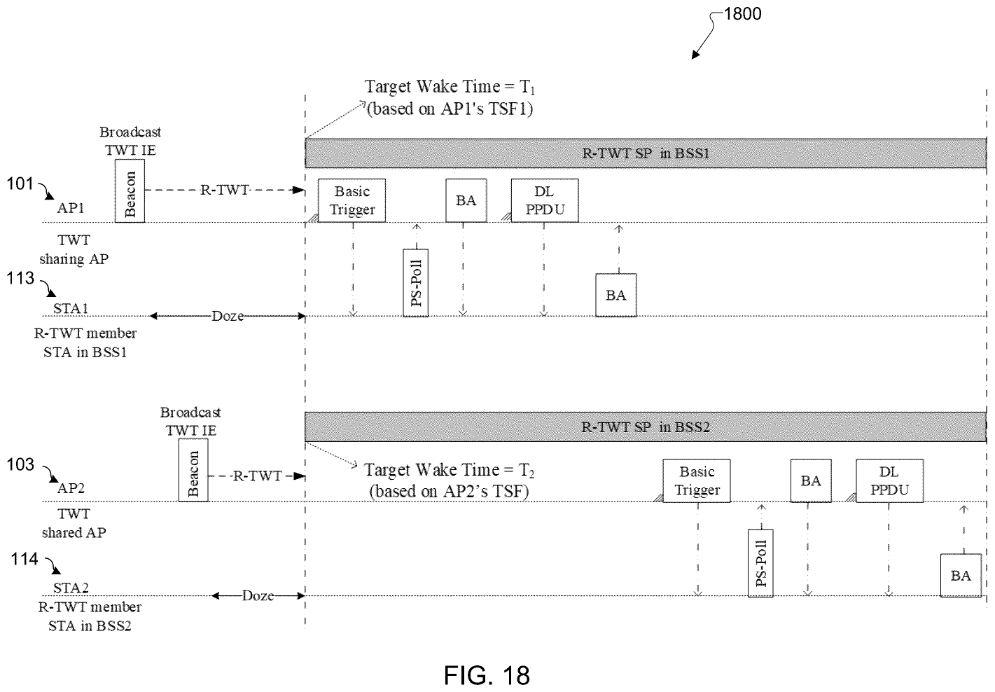

FIG. 18 illustrates an example timing diagram 1800 of a TWT shared AP advertising and establishing a coordinated R-TWT schedule in its own BSS according to embodiments of the present disclosure. In the example of FIG. 18, STA1 is associated with AP1 operating in BSS1, and STA2 is associated with AP2 operating in BSS2. AP1 is a TWT sharing AP and AP2 is a TWT shared AP in a coordinating AP set with AP1.

In the example of FIG. 18, AP2 advertises a first R-TWT schedule in BSS2 that is coordinated with a first R-TWT schedule advertised in BSS1. The TSFs of the two APs are either synchronized or the TSF difference is accounted for in the target wake time parameters such that the target wake times of the coordinated R-TWT schedules in BSS1 and BSS2 are aligned. AP2 uses the second approach for notifying/announcing the coordinated R-TWT schedule in BSS2, and accordingly STA2 is able to request and obtain membership in the coordinated R-TWT schedule in BSS2.

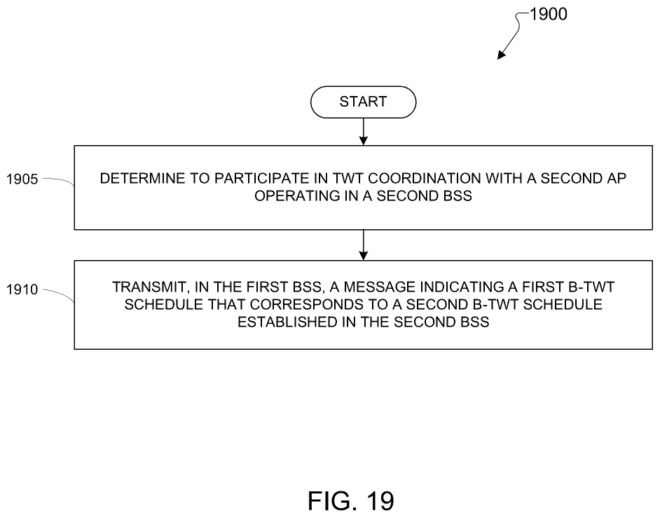

FIG. 19 illustrates an example process 1900 for facilitating MAP TWT coordination operations in a WLAN according to various embodiments of the present disclosure. The process 1900 of FIG. 19 is discussed as being performed by a first AP (in particular, a TWT shared AP), but it is understood that a corresponding second AP (a TWT sharing AP) performs a corresponding process and corresponding STAs operating in the first AP's BSS perform a corresponding process. Additionally, for convenience the process of FIG. 19 is discussed as being performed by a WI-FI AP, however, it is understood that any suitable wireless communication device could perform this process.

Referring to FIG. 19, at step 1905 the first AP may determine to participate in TWT coordination with a second AP operating in a second BSS. The first AP operates in a first BSS and the first AP, and the second AP are members of a coordinating AP set for MAP TWT coordination. The first AP may be a TWT shared AP, and the second AP is a TWT sharing AP.

Next, the first AP may transmit, in the first BSS, a message indicating a first B-TWT schedule that corresponds to a second B-TWT schedule established in the second BSS (step 1910).

In some embodiments, the first B-TWT schedule is the same as the second B-TWT schedule. The first AP may additionally configure a TWT parameter set for the first B-TWT schedule with reference to a TSF of the first AP such that a target wake time of the first B-TWT schedule is aligned with a target wake time of the second B-TWT schedule (which may reference a TSF of the second AP).

In other embodiments, the first AP may configure the first B-TWT schedule to be aligned with the second B-TWT schedule but not exactly the same as the second B-TWT schedule. That is, one or more TWT parameters corresponding to the first B-TWT schedule may differ from the counterpart TWT parameters corresponding to the second B-TWT schedule. For example, the first AP may configure the first B-TWT schedule to be aligned with the second B-TWT schedule but valid for a different number of TWT SPs than the second B-TWT schedule.

In some embodiments, the message indicating the first B-TWT schedule further comprises information indicating that the second B-TWT schedule has at least one member STA operating in the second BSS. In such embodiments, the STAs operating in the first BSS end TXOPs before a start time of a TWT SP of the first B-TWT schedule.

The MAP TWT coordination may comprise a MAP TWT announcement phase, a MAP TWT negotiation phase, an intra-BSS TWT announcement phase, an intra-BSS TWT negotiation phase, a TWT maintenance phase, and a coordination termination phase.

During the MAP TWT announcement phase, the first AP may receive, from the second AP, announcement information about the TWT coordination and respond to the announcement information from the second AP to join the coordinating AP set.

During the MAP TWT negotiation phase, the second AP may send to the coordinating AP set a TWT coordination request including TWT parameters for the second B-TWT schedule. In this case, the first AP determining to participate in the TWT coordination may comprise negotiating with the second AP based on the TWT coordination request to determine TWT parameters for the first B-TWT schedule.

Transmitting the message indicating the first B-TWT schedule in the first BSS (e.g., during the intra-BSS TWT announcement phase) may comprise distinguishing the first B-TWT schedule as a coordinated TWT schedule and dictating behavior expected from STAs operating in the first BSS for coordinated TWT schedules, or transmitting the message indicating the first B-TWT schedule such that the STAs operating in the first BSS are agnostic to whether the first B-TWT schedule is a coordinated TWT schedule.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a first access point (AP), the method comprising:
determining to participate in target wake time (TWT) coordination with a second AP operating in a second basic service set (BSS), wherein the first AP operates in a first BSS and wherein the first AP and the second AP are members of a coordinating AP set for multi-AP (MAP) TWT coordination; and
transmitting, in the first BSS, a message indicating a first broadcast TWT (B-TWT) schedule that corresponds to a second B-TWT schedule established in the second BSS.

2. The method of claim 1, wherein:
the first B-TWT schedule is the same as the second B-TWT schedule, and
the method further comprises configuring a TWT parameter set for the first B-TWT schedule with reference to a timing synchronization function (TSF) of the first AP such that a target wake time of the first B-TWT schedule is aligned with a target wake time of the second B-TWT schedule.

3. The method of claim 1, further comprising configuring the first B-TWT schedule to be aligned with the second B-TWT schedule but not exactly the same as the second B-TWT schedule.

4. The method of claim 1, further comprising configuring the first B-TWT schedule to be aligned with the second B-TWT schedule but valid for a different number of TWT service periods (SPs) than the second B-TWT schedule.

5. The method of claim 1, wherein the message indicating the first B-TWT schedule comprises information indicating that:
stations (STAs) operating in the first BSS cannot be members of the first B-TWT schedule, or
only STAs operating in the second BSS can be members of the first B-TWT schedule.

6. The method of claim 5, wherein:
the message indicating the first B-TWT schedule further comprises information indicating that the second B-TWT schedule has at least one member STA operating in the second BSS, and
the STAs operating in the first BSS end transmission opportunities (TXOPs) before a start time of a TWT SP of the first B-TWT schedule.

7. The method of claim 1, wherein MAP TWT coordination comprises:
a MAP TWT announcement phase,
a MAP TWT negotiation phase,
an intra-BSS TWT announcement phase,
an intra-BSS TWT negotiation phase,
a TWT maintenance phase, and
a coordination termination phase.

8. The method of claim 7, wherein the method further comprises, during the MAP TWT announcement phase:
receiving, from the second AP, announcement information about the TWT coordination, and
responding to the announcement information from the second AP to join the coordinating AP set.

9. The method of claim 7, wherein during the MAP TWT negotiation phase:
the second AP sends to the coordinating AP set a TWT coordination request including TWT parameters for the second B-TWT schedule, and
determining to participate in the TWT coordination comprises negotiating with the second AP based on the TWT coordination request to determine TWT parameters for the first B-TWT schedule.

10. The method of claim 1, wherein transmitting the message indicating the first B-TWT schedule in the first BSS comprises:
distinguishing the first B-TWT schedule as a coordinated TWT schedule and dictating behavior expected from STAs operating in the first BSS for coordinated TWT schedules, or
transmitting the message indicating the first B-TWT schedule such that the STAs operating in the first BSS are agnostic to whether the first B-TWT schedule is a coordinated TWT schedule.

11. A method performed by a wireless station (STA), the method comprising:
receiving, in a first BSS from a first access point (AP), a message indicating a first broadcast target wake time (B-TWT) schedule that corresponds to a second B-TWT schedule established in a second BSS; and
adjusting operations of the STA based on the message to account for the first B-TWT schedule,
wherein the STA and the first AP operate in the first BSS, and
wherein the first AP and a second AP operating in the second BSS are members of a coordinating AP set for multi-AP (MAP) TWT coordination and the first AP has determined to participate in TWT coordination with the second AP.

12. The method of claim 11, wherein:
the first B-TWT schedule is the same as the second B-TWT schedule, and
a TWT parameter set for the first B-TWT schedule is configured with reference to a timing synchronization function (TSF) of the first AP such that a target wake time of the first B-TWT schedule is aligned with a target wake time of the second B-TWT schedule.

13. The method of claim 11, wherein the first B-TWT schedule is aligned with the second B-TWT schedule but not exactly the same as the second B-TWT schedule.

14. The method of claim 11, wherein the first B-TWT schedule is aligned with the second B-TWT schedule but valid for a different number of TWT service periods (SPs) than the second B-TWT schedule.

15. The method of claim 11, wherein the message indicating the first B-TWT schedule comprises information indicating that:
STAs operating in the first BSS cannot be members of the first B-TWT schedule, or
only STAs operating in the second BSS can be members of the first B-TWT schedule.

16. The method of claim 15, wherein:
the message indicating the first B-TWT schedule further comprises information indicating that the second B-TWT schedule has at least one member STA operating in the second BSS, and
adjusting the operations of the STA to account for the first B-TWT schedule comprises ending a transmission opportunity (TXOP) before a start time of a TWT SP of the first B-TWT schedule.

17. The method of claim 11, wherein MAP TWT coordination comprises:
a MAP TWT announcement phase,
a MAP TWT negotiation phase,
an intra-BSS TWT announcement phase,
an intra-BSS TWT negotiation phase,
a TWT maintenance phase, and
a coordination termination phase.

18. The method of claim 17, wherein during the MAP TWT announcement phase:
the first AP receives, from the second AP, announcement information about the TWT coordination, and
the first AP responds to the announcement information from the second AP to join the coordinating AP set.

19. The method of claim 17, wherein during the MAP TWT negotiation phase:
the second AP sends to the coordinating AP set a TWT coordination request including TWT parameters for the second B-TWT schedule, and
the first AP, to determine to participate in the TWT coordination, negotiates with the second AP based on the TWT coordination request to determine TWT parameters for the first B-TWT schedule.

20. The method of claim 11, wherein:
the message indicating the first B-TWT schedule distinguishes the first B-TWT schedule as a coordinated TWT schedule and the first AP dictates behavior expected from STAs operating in the first BSS for coordinated TWT schedules, or
the STA is agnostic to whether the first B-TWT schedule is a coordinated TWT schedule.
